(19) United States
(12) Patent Application Publication
(10) Pub. No.: US 2020/0341178 A1
(43) Pub. Date: Oct. 29, 2020

(54) DISPLAY DEVICE AND TERMINAL

(71) Applicant: WUHAN CHINA STAR OPTOELECTRONICS TECHNOLOGY CO., LTD., Wuhan (CN)

(72) Inventor: Zhounian WU, Wuhan (CN)

(73) Assignee: WUHAN CHINA STAR OPTOELECTRONICS TECHNOLOGY CO., LTD., Wuhan (CN)

(21) Appl. No.: 16/496,458

(22) PCT Filed: Jul. 15, 2019
(86) PCT No.: PCT/CN2019/096019

§ 371 Date: Sep. 23, 2019

(30) Foreign Application Priority Data
Apr. 23, 2019 (CN) 201910327082.3

(51) Int. Cl. G02B 5/30; G02B 1/11

(52) U.S. Cl. CPC G02B 5/3041; G02B 1/11

(57) ABSTRACT

The present invention embodiment discloses a display device and a terminal. The display device includes a first display module. The first display module includes a first substrate and a second substrate disposed oppositely. A first polarizer is disposed on a side of the first substrate away from second substrate. A second polarizer is disposed on a side of the second substrate away from first substrate. A first blind hole is defined in a first polarizer, and at least one anti-reflective film is disposed in the first blind hole. the present invention improves transmittance of transmitted light of the display device.

### FIELD OF INVENTION

The present invention relates to a field of display technologies, especially to a display device and a terminal.

### BACKGROUND OF INVENTION

The society is developing, science and technology are advancing, and people entering the 21^{st} century are increasingly demanding terminal electronic products. Full screen design has become a main trend of development of terminal display panels. Technologies of cutout screen, widow's peak screen, droplet screen are sequentially set forth and in mass production.

At present, a design of a blind hole screen of display panel with a super high screen ratio is complimented by industries. Compared to other full screen technologies, poor transmittance in the blind hole is one of main issues that need to be overcome. A solution for the issue is changing an array film structure in the array substrate to leave only a buffer layer, and filling optical clear adhesive into a step difference in the blind hole due to a hollowed polarizer. However, array film processes for the solution has high are highly demanded and complicated, and precision of filling of the optical clear adhesive is difficult to control.

### SUMMARY OF INVENTION

The present invention provides a display device and a terminal that avoid poor transmittance in a blind hole, removing filling of optical clear adhesive into a step difference in the blind hole due to a hollowed polarizer, and provide a solution for the display device applied to a next terminal with a high screen ratio.

The present invention provides a display device, wherein the display device comprises a first display module, the first display module comprises a first substrate and a second substrate disposed oppositely, a first polarizer is disposed on a side of the first substrate away from the second substrate, a second polarizer is disposed on a side of the second substrate away from the first substrate, a first blind hole is defined in the first polarizer, and at least one anti-reflective film is disposed in the first blind hole;

wherein the display device comprises a second display module, the second display module comprises a third substrate and a fourth substrate disposed oppositely, a third polarizer is disposed on a side of the third substrate away from the fourth substrate, a fourth polarizer is disposed on a side of the fourth substrate away from the third substrate, a second blind hole is defined in the third polarizer, and at least one anti-reflective film is disposed in the second blind hole;

wherein the second substrate is a first array substrate, the first array substrate comprises an array film, and the array film only comprises a buffer layer.

In some embodiments of the present invention, a third blind hole is defined in the first polarizer, and at least one anti-reflective film is disposed in the third blind hole.

In some embodiments of the present invention, a number of the at least one anti-reflective film is a predetermined number such that transmittance of transmitted light is not less than 96%.

In some embodiments of the present invention, the second substrate is a first array substrate, the first array substrate comprises an array film, and the array film only comprises a buffer layer.

In some embodiments of the present invention, the second substrate is a second array substrate, the second array substrate comprises an array film, and the array film comprises a buffer layer, a gate insulation layer, an electrodeless layer, a pixel definition layer, an interlayer dielectric layer and an insulation layer.

The present invention also provides a display device, the display device comprises a first display module, the first display module comprises a first substrate and a second substrate disposed oppositely, a first polarizer is disposed on a side of the first substrate away from the second substrate, a second polarizer is disposed on a side of the second substrate away from the first substrate, a first blind hole is defined in the first polarizer, and at least one anti-reflective film is disposed in the first blind hole.

In some embodiments of the present invention, the display device comprises a second display module, the second display module comprises a third substrate and a fourth substrate disposed oppositely, a third polarizer is disposed on a side of the third substrate away from the fourth substrate, a fourth polarizer is disposed on a side of the fourth substrate away from the third substrate, a second blind hole is defined in the third polarizer, and at least one anti-reflective film is disposed in the second blind hole.

In some embodiments of the present invention, a third blind hole is defined in the first polarizer, and at least one anti-reflective film is disposed in the third blind hole.

In some embodiments of the present invention, a number of the at least one anti-reflective film is a predetermined number such that transmittance of transmitted light is not less than 96%.

In some embodiments of the present invention, the second substrate is a first array substrate, the first array substrate comprises an array film, and the array film only comprises a buffer layer.

In some embodiments of the present invention, the second substrate is a second array substrate, the second array substrate comprises an array film, and the array film comprises a buffer layer, a gate insulation layer, an electrodeless layer, a pixel definition layer, an interlayer dielectric layer and an insulation layer.

The present invention also provides a terminal, the terminal comprises a first display module and a first camera, the first display module comprises a first substrate and a second substrate disposed oppositely, a first polarizer is disposed on a side of the first substrate away from the second substrate, a second polarizer is disposed on a side of the second substrate away from the first substrate, a first blind hole is defined in the first polarizer, and at least one anti-reflective film is disposed in the first blind hole, a fourth blind hole is defined in the second polarizer, and the first camera is disposed in a position corresponding to the fourth blind hole.

In some embodiments of the present invention, a number of the at least one anti-reflective film is a predetermined number such that transmittance of transmitted light is not less than 96%.

In some embodiments of the present invention, the first display module, the first camera, the second display module, and the second camera of the terminal are all located on a same side of the terminal; or the first display module and the first camera are located on a side of the terminal, and the second display module and the second camera are located on another side of the terminal.

In some embodiments of the present invention, the terminal comprises a second display module and a second camera, the second display module comprises a third substrate and a fourth substrate disposed oppositely, a third polarizer is disposed on a side of the third substrate away from the fourth substrate, a fourth polarizer is disposed on a side of the fourth substrate away from the third substrate, a second blind hole is defined in the third polarizer, and at least one anti-reflective film is disposed in the second blind hole, a fifth blind hole is defined in the fourth polarizer, and the second camera is disposed in a position corresponding to the fifth blind hole.

In some embodiments of the present invention, a third blind hole is defined in the third polarizer, and the third camera is disposed in a position corresponding to the third blind hole.

In some embodiments of the present invention, the terminal comprises a second display module and a second camera, the second display module comprises a third substrate and a fourth substrate disposed oppositely, a third polarizer is disposed on a side of the third substrate away from the fourth substrate, a fourth polarizer is disposed on a side of the fourth substrate away from the third substrate, a second blind hole is defined in the third polarizer, and at least one anti-reflective film is disposed in the second blind hole, a fifth blind hole is defined in the fourth polarizer, and the second camera is disposed in a position corresponding to the fifth blind hole;

a third blind hole is defined in the third polarizer, and the third camera is disposed in a position corresponding to the third blind hole.

In some embodiments of the present invention, the first display module, the first camera, the second display module, and the second camera of the terminal are all located on a same side of the terminal.

In some embodiments of the present invention, the first display module and the first camera are located on a side of the terminal, and the second display module and the second camera are located on another side of the terminal.

In some embodiments of the present invention, the terminal can be adapted for a smart terminal, a tablet apparatus, or a wearable apparatus.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a schematic view of a structure of an embodiment of a display device provided by the present invention embodiment;

FIG. 2 is a schematic view of a structure of another embodiment of a display device provided by the present invention embodiment;

FIG. 3 is a schematic view of a structure of an embodiment of a terminal provided by the present invention embodiment; and

FIG. 4 is a schematic view of a structure of another embodiment of a terminal provided by the present invention embodiment.

### DETAILED DESCRIPTION OF PREFERRED EMBODIMENTS

The technical solution in the embodiment of the present invention will be clearly and completely described below with reference to the accompanying drawings in the embodiments of the present invention. Apparently, the described embodiments are merely some embodiments of the present invention instead of all embodiments. According to the embodiments in the present invention, all other embodiments obtained by those skilled in the art without making any creative effort shall fall within the protection scope of the present invention.

In the description of the present invention, it should be understood that terminologies “center”, “longitudinal”, “transverse”, “length”, “width”, “thickness”, “upper”, “lower”, “front”, “rear”, “left”, “side”, “vertical”, “horizontal”, “top”, “bottom”, “inner”, “outer”, “clockwise”, “counterclockwise” for indicating relations of orientation or position are based on orientation or position of the accompanying drawings, are only for the purposes of facilitating description of the present invention and simplifying the description instead of indicating or implying that the referred device or element must have a specific orientation or position, must to be structured and operated with the specific orientation or position. Therefore, they should not be understood as limitations to the present invention. Furthermore, terminologies “first”, “second” are only for the purposes of description, and cannot be understood as indication or implication of comparative importance or a number of technical features. Therefore, a feature limited with “first”, “second” can expressly or implicitly include one or more features. In the description of the present invention, a meaning of “a plurality of” is two or more, unless there is a clear and specific limitation otherwise.

In the present invention, the word “exemplary” is used to mean “serving as an example, illustration or description”. Any embodiment described as “exemplary” in the present invention is not necessarily construed as preferred or more advantageous over other embodiments. In order to enable any person skilled in the art to implement and use the present invention, the following description is given. In the following description, details are set forth for the purpose of explanation. It should be understood that a person of ordinary skill In the art will appreciate that the present invention may be implemented without the use of these specific details. In other instances, the known structures and processes are not elaborated to avoid unnecessary details from making descriptions of the present invention becomes ambiguous. Therefore, the present invention is not intended to be limited to the illustrated embodiment, but is consistent with the broadest scope of the principles and features disclosed by the present invention.

At present, a terminal with a super high screen ratio employs a blind hole design that installed a front camera into terminal. However, due to self-defects of the blind hole design, transmittance of transmitted light is poor and influences quality of the photographed images.

Accordingly, the present invention embodiment provides a display device and a terminal that will be described in details as follows respectively.

First, an embodiment of the present invention provides a display device. The display device comprises a first display module, the first display module comprises a first substrate and a second substrate that are disposed oppositely. A first polarizer is disposed on a side of the first substrate away from the second substrate, and a second polarizer is disposed on a side of the second substrate away from the first substrate. A first blind hole is defined in the first polarizer, and at least one anti-reflective film is disposed in the first blind hole.

In optical instruments, reflection of a surface of an optical element affects transmittance. Furthermore, reflective light forms diffusing light in the optical instruments, which decreases image quality of the optical instruments. To solve the above issues, a single layer coating or a multi-layer coating with a certain thickness is plated on the optical element with a purpose reducing reflective light on the surface of the optical element. Such coating is called optical anti-reflective film.

The principle of the optical anti-reflective film is analyzed from the perspective of energy conservation. Under normal circumstances, when incident light encounters a surface of an optical element with specific material, energies of reflective light and transmitted light are constant. Without consideration of factors such as light absorption and diffusion, total energy of reflective light and transmitted light is equal to energy of the incident light. In other words, the law of conservation of energy is fulfilled. After the optical element is coated, without consideration of factors such as light absorption and diffusion of light, the reflective light, transmitted light, and incident light still fulfills the law of conservation of energy. The function of the coating is redistributing the energy of the reflective light and transmitted light. For an anti-reflective film, a result of redistribution is lowered energy of the reflective light and increase energy of the transmitted light. Thus, anti-reflective film redistributes the energy of the reflective light and transmitted light on the surface of the optical element, and the result of redistribution is lowered energy of the reflective light and increase energy of the transmitted light. Light has such characteristic that an intensity of the transmitted light can be changed by changing an intensity of the reflective light.

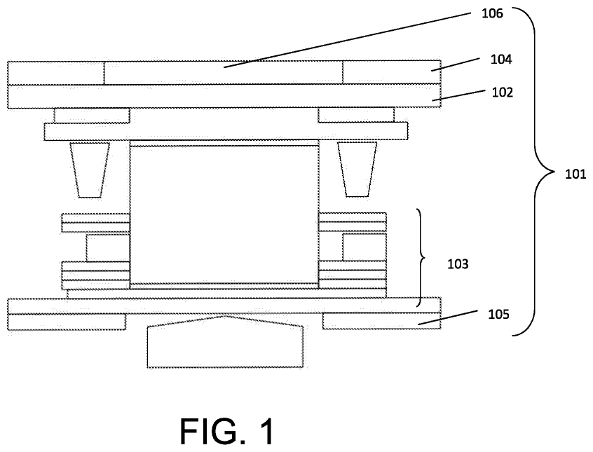

With reference to FIG. 1, FIG. 1 is a schematic view of a structure of an embodiment of a display device provided by the present invention embodiment. The display device comprises a first display module 101. The first display module 101 comprises a first substrate 102 and a second substrate 103 that are disposed oppositely. A first polarizer 104 is disposed on a side of the first substrate 102 away from the second substrate 103, and a second polarizer 105 is disposed on a side of the second substrate 103 away from the first substrate 102. A first blind hole is defined in the first polarizer, and at least one anti-reflective film 106 is disposed in the first blind hole.

In the present invention embodiment, the first display module 101 comprises a first substrate 102 and a second substrate 103 that are disposed oppositely. A first polarizer 104 is disposed on a side of the first substrate 102 away from the second substrate 103, and a second polarizer 105 is disposed on a side of the second substrate 103 away from the first substrate 102. A first blind hole is defined in the first polarizer, and at least one anti-reflective film 106 is disposed in the first blind hole. A thickness of the anti-reflective film fills the step difference of the polarizer that is hollowed, and the anti-reflective film directly improves transmittance of transmitted light.

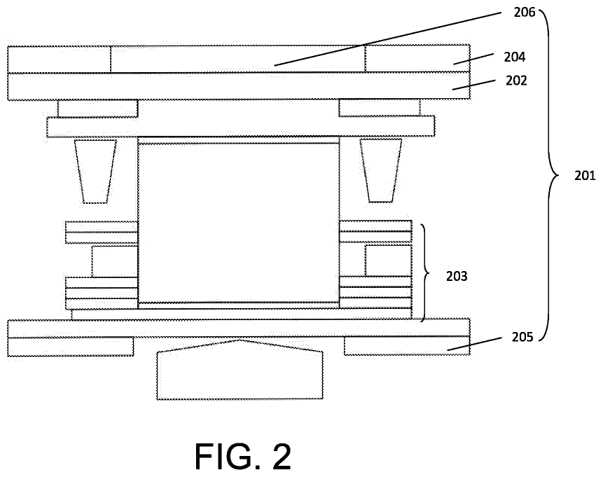

On the basis of the above embodiment, in another preferred embodiment of the present invention, as shown in FIG. 2, the display device comprises a second display module 201. The second display module 201 comprises a third substrate 202 and a fourth substrate 203 that are disposed oppositely. A third polarizer 204 is disposed on a side of the third substrate 202 away from the fourth substrate 203, and a fourth polarizer 205 is disposed on a side of the fourth substrate 203 away from the third substrate 202. A second blind hole is defined in the third polarizer 204, and at least one anti-reflective film 206 is disposed in the second blind hole.

A number of the at least one anti-reflective film is a predetermined number such that transmittance of transmitted light is not less than 96%.

On the basis of the above embodiment, in another preferred embodiment of the present invention, a third blind hole is defined in the first polarizer, and at least one anti-reflective film is disposed in the third blind hole.

On the basis of the above embodiment, in another preferred embodiment of the present invention, the second substrate 103 is a first array substrate, the first array substrate comprises an array film, the array film only comprises a buffer layer.

In the current technologies, when a certain amount of transmittance is changed only, a device of the display module affects transmittance of the transmitted light certainly. Therefore, in some embodiments of the present invention, a portion of the array film in the first array substrate 103 can be dug out, for example, only the buffer layer is preserved.

On the basis of the above embodiment, in a specific embodiment of the present invention, when at least one anti-reflective film is adopted, and transmittance of the transmitted light is fulfilled, processing a first array substrate in the display module is unnecessary. For example, the second substrate is a second array substrate, and the second array substrate comprises an array film. The array film comprises a buffer layer, a gate insulation layer, an electrodeless layer, a pixel definition layer, an interlayer dielectric layer, and an insulation layer.

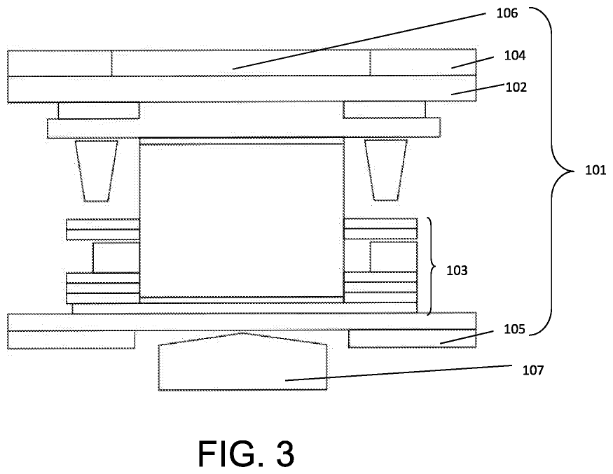

To better embody the display device in the present invention embodiment, on the basis of the display device, the present invention embodiment also provides a terminal, as shown in FIG. 3. The terminal comprises a first display module 101 and a first camera 107. The first display module 101 comprises a first substrate 102 and a second substrate 103 that are disposed oppositely. A first polarizer 104 is disposed on a side of the first substrate 102 away from the second substrate 103, and a second polarizer 105 is disposed on a side of the second substrate 103 away from the first substrate 102. A first blind hole is defined in the first polarizer, and at least one anti-reflective film 106 is disposed in the first blind hole. A fourth blind hole is defined in the second polarizer 105, and the first camera 107 is disposed in a position corresponding to the fourth blind hole.

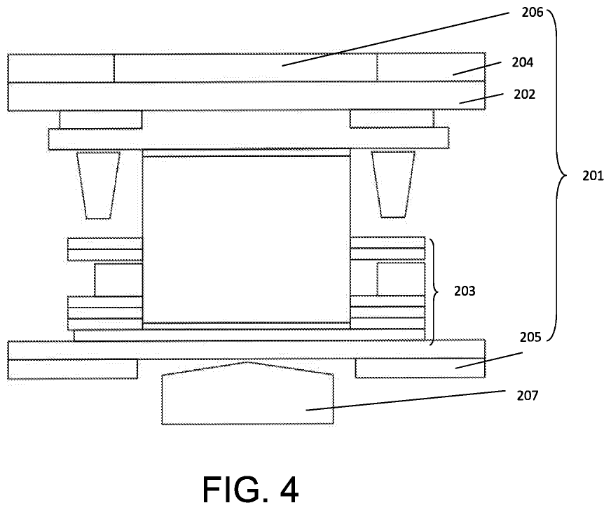

On the basis of the above embodiment, in another preferred embodiment of the present invention, as shown in FIG. 4, the terminal comprises a second display module 201 and a second camera 207. The second display module 201 comprises a third substrate 202 and a fourth substrate 203 that are disposed oppositely. A third polarizer 204 is disposed on a side of the third substrate 202 away from the fourth substrate 203, and a fourth polarizer 205 is disposed on a side of the fourth substrate 203 away from the third substrate 202. A second blind hole is defined in the third polarizer 204, and at least one anti-reflective film 206 is disposed in the second blind hole. A fifth blind hole is defined in the fourth polarizer 205, and the second camera 207 is disposed in a position corresponding to the fifth blind hole.

On the basis of the above embodiment, in another preferred embodiment of the present invention, a third blind hole is defined in the third polarizer 204, and the third camera disposed in a position corresponding to the third blind hole. the present invention does not limit a specific position of the blind hole of display module in the terminal, the position can be on a left upper corner of the terminal or on a right upper corner thereof depending on actual conditions.

For example, in a display module, two cameras are installed simultaneously thereon, and in another display module, a third camera is disposed thereon, and the position of the blind hole of the camera is not limited.

On the basis of the above embodiment, in another preferred embodiment of the present invention, the first display module, the first camera, the second display module, and the second camera of the terminal are all located on a same side of the terminal.

For example, when two display modules are on a side, each display module corresponds to a camera, which can satisfy wide angle photography. With a clever design, use of the terminal can be versatile, and two cameras can be used to photograph at same time for multi-position filming.

On the basis of the above embodiment, in another preferred embodiment of the present invention, the first display module and the first camera are located on a side of the terminal, and the second display module and the second camera are located on another side of the terminal.

For example, when displaying regions are on front and rear surfaces of the terminal, the front and rear surfaces of the terminal can be installed with the display devices of the present invention, and cameras on the terminal can be used simultaneously, to photograph on the front surface and the rear surface and allow two people to selfie simultaneously. Each of the surfaces can be installed with one or more display devices of the present invention.

In the present invention embodiment, the above terminal can be a smart terminal, a tablet apparatus, and a wearable apparatus, which is not limited herein.

Compared to related technical solutions, in the solutions of the terminal provided by the embodiments of the present invention, the versatility of use of the display device not only increases the screen ratio of the electrical device but also guarantees photographing and displaying quality of the terminal to extremely enhance performance of the terminal.

In the embodiments, the descriptions of the various embodiments are all important. For embodiments that are not described in details, refer to the detailed description of other embodiments above, and details are not described repeatedly here.

In the specific implementation, each of the above units or structures may be implemented as a separate entity, or may be any combination, and implemented as the same entity or a plurality of entities. For the specific implementation of the above units or structures, refer to the previous method, embodiment, and is not described repeatedly here.

For the specific operation of the above units or structures, refer to the previous method, embodiment, and is not described repeatedly here.

As described above, the display device and the terminal provided by the present invention embodiment has been introduced in details. In the specification, the specific examples are used to explain the principle and implementation of the present invention. The description of the above embodiments is only used to help understand the method of the present invention and its core ideas. At the same time, for a person of ordinary skill in the art according to the concept of the present invention, there will be changes in the specific embodiments and application extent. In summary, the contents of this specification should not be construed as limiting the present invention.

What is claimed is:

1. A display device, wherein the display device comprises a first display module, the first display module comprises a first substrate and a second substrate disposed oppositely, a first polarizer is disposed on a side of the first substrate away from the second substrate, a second polarizer is disposed on a side of the second substrate away from the first substrate, a first blind hole is defined in the first polarizer, and at least one anti-reflective film is disposed in the first blind hole;
wherein the display device comprises a second display module, the second display module comprises a third substrate and a fourth substrate disposed oppositely, a third polarizer is disposed on a side of the third substrate away from the fourth substrate, a fourth polarizer is disposed on a side of the fourth substrate away from the third substrate, a second blind hole is defined in the third polarizer, and at least one anti-reflective film is disposed in the second blind hole;
wherein the second substrate is a first array substrate, the first array substrate comprises an array film, and the array film only comprises a buffer layer.

2. The display device as claimed in claim 1, wherein a third blind hole is defined in the first polarizer, and at least one anti-reflective film is disposed in the third blind hole.

3. The display device as claimed in claim 1, wherein a number of the at least one anti-reflective film is a predetermined number such that transmittance of transmitted light is not less than 96%.

4. The display device as claimed in claim 1, wherein the second substrate is a first array substrate, the first array substrate comprises an array film, and the array film only comprises a buffer layer.

5. The display device as claimed in claim 1, wherein the second substrate is a second array substrate, the second array substrate comprises an array film, and the array film comprises a buffer layer, a gate insulation layer, an electrodeless layer, a pixel definition layer, an interlayer dielectric layer and an insulation layer.

6. A display device, wherein the display device comprises a first display module, the first display module comprises a first substrate and a second substrate disposed oppositely, a first polarizer is disposed on a side of the first substrate away from the second substrate, a second polarizer is disposed on a side of the second substrate away from the first substrate, a first blind hole is defined in the first polarizer, and at least one anti-reflective film is disposed in the first blind hole.

7. The display device as claimed in claim 6, wherein the display device comprises a second display module, the second display module comprises a third substrate and a fourth substrate disposed oppositely, a third polarizer is disposed on a side of the third substrate away from the fourth substrate, a fourth polarizer is disposed on a side of the fourth substrate away from the third substrate, a second blind hole is defined in the third polarizer, and at least one anti-reflective film is disposed in the second blind hole.

8. The display device as claimed in claim 6, wherein a third blind hole is defined in the first polarizer, and at least one anti-reflective film is disposed in the third blind hole.

9. The display device as claimed in claim 6, wherein a number of the at least one anti-reflective film is a predetermined number such that transmittance of transmitted light is not less than 96%.

10. The display device as claimed in claim 6, wherein the second substrate is a first array substrate, the first array substrate comprises an array film, and the array film only comprises a buffer layer.

11. The display device as claimed in claim 6, wherein the second substrate is a second array substrate, the second array substrate comprises an array film, and the array film comprises a buffer layer, a gate insulation layer, an electrodeless layer, a pixel definition layer, an interlayer dielectric layer and an insulation layer.

12. A terminal, wherein the terminal comprises a first display module and a first camera, the first display module comprises a first substrate and a second substrate disposed oppositely, a first polarizer is disposed on a side of the first substrate away from the second substrate, a second polarizer is disposed on a side of the second substrate away from the first substrate, a first blind hole is defined in the first polarizer, and at least one anti-reflective film is disposed in the first blind hole, a fourth blind hole is defined in the second polarizer, and the first camera is disposed in a position corresponding to the fourth blind hole.

13. The terminal as claimed in claim 12, wherein a number of the at least one anti-reflective film is a predetermined number such that transmittance of transmitted light is not less than 96%.

14. The terminal as claimed in claim 12, wherein the second substrate is a first array substrate, the first array substrate comprises an array film, and the array film only comprises a buffer layer.

15. The terminal as claimed in claim 12, wherein the second substrate is a second array substrate, the second array substrate comprises an array film, and the array film comprises a buffer layer, a gate insulation layer, an electrodeless layer, a pixel definition layer, an interlayer dielectric layer and an insulation layer.

16. The terminal as claimed in claim 12, wherein the terminal comprises a second display module and a second camera, the second display module comprises a third substrate and a fourth substrate disposed oppositely, a third polarizer is disposed on a side of the third substrate away from the fourth substrate, a fourth polarizer is disposed on a side of the fourth substrate away from the third substrate, a second blind hole is defined in the third polarizer, and at least one anti-reflective film is disposed in the second blind hole, a fifth blind hole is defined in the fourth polarizer, and the second camera is disposed in a position corresponding to the fifth blind hole.

17. The terminal as claimed in claim 12, wherein a third blind hole is defined in the third polarizer, and the third camera is disposed in a position corresponding to the third blind hole.

18. The terminal as claimed in claim 12, wherein the first display module, the first camera, the second display module, and the second camera of the terminal are all located on a same side of the terminal.

19. The terminal as claimed in claim 12, wherein the first display module and the first camera are located on a side of the terminal, and the second display module and the second camera are located on another side of the terminal.
